(19) United States
(12) Patent Application Publication
(10) Pub. No.: US 2002/0106132 A1
(43) Pub. Date: Aug. 8, 2002

(54) Apparatus and method for encoding image data

(75) Inventor: Minoru Suzuki, Yokohama-shi (JP)

Correspondence Address: Johnny A. Kumar, FOLEY & LARDNER, 3000 K Street, N.W., Suite 500, P.O. Box 25696, Washington, DC, 20007-5109, US

(73) Assignee: TOSHIBA TEC KABUSHIKI KAISHA

(21) Appl. No.: 09/773,513

(22) Filed: Feb. 2, 2001

(51) Int. Cl. G06K 9/36

(52) U.S. Cl. 382/245

(57) ABSTRACT

An apparatus for encoding image data of the present invention is provided with a one-dimensional encoder which encodes image data one-dimensionally, a two-dimensional encoder which encodes image data two-dimensionally, a thin line determination section which determines the frequency of occurrence of short run-length from a run-length count value during encoding of lines applied with the one-dimensional encoding, and an encoding control section which, when it is determined from the determination result in the thin line determination section that the frequency of occurrence of the short run-length is high, restricts the number of lines which are applied with the second-dimensional encoding within a predetermined range.

### BACKGROUND OF THE INVENTION

The present invention relates to an apparatus and a method for encoding image data where an optimal encoding system is selected according to image data to enhance a processing efficiency of the image data.

Conventionally, regarding such an apparatus for encoding image data, there have been proposed various techniques.

FIG. 1 is a configuration diagram of an apparatus for encoding image data according to the conventional art.

AS shown in FIG. 1, image data transmitted from an external scanner section or the like is input in a one-dimensional encoder via a run-length determination section. Furthermore, the image data is input in a two-dimensional encoder directly or via a line memory section. In the run-length determination section, the run-length about the image data is determined. The determination result is output to a Huffman table.

In this Huffman table, data corresponding to the determination result is output in the one-dimensional encoder. In an encoded data creating section, encoded data is generated on the basis of the outputs of the one-dimensional encoder and the second-dimensional encoder. This encoded data is output to an external modem section or the like. An encoding control section controls the one-dimensional encoder, the two-dimensional encoder and the encoded data creating section on the basis of K parameter set by an external main CPU or the like.

Besides, in Jpn. Pat. Appln. KOKAI Publication No. 8-32819 publication, there has been disclosed a technique where a switching between a MH (one-dimensional) encoding system and a MR (two-dimensional) encoding system is performed according to image data to improve compression efficiency.

Furthermore, in Jpn. Pat. Appln. KOKAI Publication No. 9-294197 publication, there has been disclosed a technique where an influence range of error is restricted at a decoding time of MMR encoded data.

Also, in Jpn. Pat. Appln. KOKAI Publication No. 11-341198, there has been disclosed a technique where an image is transmitted with an optimal resolution according to the contents of the image so that the interpretation thereof is made easy.

In a facsimile communication, however, when MR encoded data transmission is performed in a mode where error correction is not performed, such as G3 mode which does not have an option for error correction performed according to restrictions of a facsimile modem of a communication receiving side or qualities of communication line, one-dimensional encoding for one line and two-dimensional encoding for the remaining lines are performed at a cycle of the number of lines set by K parameter in the MR encoding. Therefore, for example, when the first line includes an error in a block, the influence of the error is propagated to the subsequent lines. In particular, in a case of an image including a small characters or a thin lines, such an influence acts as a large obstacle to interpretation of the image decoded.

### BRIEF SUMMARY OF THE INVENTION

An object of the present invention is to determine the frequency of thin lines in an image from the contents of run-length value at a time of one-dimensional encoding in MR encoding to restrict the number of lines applied with two-dimensional encoding, thereby reducing influence of communication error to the image according to the contents of the image when transmission of MR encoding data is performed in a facsimile communication mode or the like where error correction is not made.

In order to achieve the above object, as a first aspect, there is provided an apparatus for encoding image data comprising: a one-dimensional encoder which encodes image data one-dimensionally; a two-dimensional encoder which encodes image data two-dimensionally; a thin line determination section which determines the frequency of occurrence of short run-length from a run-length count value during encoding of lines applied with the one-dimensional encoding; and an encoding control section which, when it is determined from the determination result in the thin line determination section that the frequency of occurrence of the short run-length is high, restricts the number of lines which are applied with the second-dimensional encoding within a predetermined range.

As a second aspect, there is provided an apparatus for encoding image data comprising: a one-dimensional encoder which encodes image data one-dimensionally; a two-dimensional encoder which encodes image data two-dimensionally; a run-length determination section which determines run-lengths during encoding of lines applied with the one-dimensional encoding to obtain a run-length count value; a thin line determination section which determines the frequency of occurrence of a short run-length on the basis of the run-length count value; an encoding control section which is subjected to setting of K parameter externally and when it is determined from the determination result in the thin line determination section that the frequency of occurrence of the short run-length is high, determines that many small characters and/or thin lines are contained in a document to restrict the number of lines applied with the two-dimensional encoding within a predetermined range specified by the K parameter.

As a third aspect, there is provided a method for encoding image data comprising: a first step of one-dimensionally encoding image data; a second step of two-dimensionally encoding image data; a third step of determining the frequency of occurrence of a short run-length from a run-length count value during encoding of lines applied with the one-dimensional encoding; and a fourth step of restricting the number of lines applied with the two-dimensional encoding within a predetermined range when it is determined from the determination result that the frequency of occurrence of the short run-length is high.

As a fourth aspect, there is provided a method for encoding image data comprising: a first step of one-dimensionally encoding image data; a second step of two-dimensionally encoding image data; a third step of determining run-lengths during encoding of lines applied with the one-dimensional encoding to obtain a run-length count value; a fourth step of the frequency of occurrence of the short run-length on the basis of the run-length count value; a fifth step of performing setting of K parameter externally; a sixth step of determining that many small characters and/or thin lines are contained in a document to restrict the number of lines applied with the two-dimensional encoding within a predetermined range specified by the K parameter, when it is determining that the frequency of occurrence of the short run-length is high from the determination result in the fourth step.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a configuration of an encoding apparatus according to a related art;

FIG. 2 is a block diagram showing a configuration of an apparatus for encoding image data according to a first embodiment of the present invention;

FIG. 3 is a flowchart for explaining characterized operation of the apparatus for encoding image data according to the first embodiment in detail;

FIG. 4 is a diagram for explaining characterized operation of the apparatus for encoding image data according to the first embodiment in detail;

FIG. 5 is a diagram for explaining characterized operation of the apparatus for encoding image data according to the first embodiment in detail;

FIG. 6 is a block diagram showing a configuration of an apparatus for encoding image data according to a second embodiment:

FIG. 7 is a flowchart for explaining characterized operation of the apparatus for encoding image data according to the second embodiment in detail;

FIG. 8 is a block diagram showing a configuration of an apparatus for encoding image data according to a third embodiment; and

FIG. 9 is a flowchart for explaining characterized operation of the apparatus for encoding image data according to the third embodiment in detail.

### DETAILED DESCRIPTION OF THE INVENTION

In an apparatus for encoding image data according to the present invention, the frequency of occurrence of thin lines in an image is determined from a run-length value during one-dimensional coding according to a MR encoding system. Then, for the subsequent lines, the number of lines which are to be applied with a two-dimensional encoding system is restricted on the basis of the determination result. Thereby, influence of communication error on an image or the like is reduced.

First to third embodiments will be explained in detail with reference to the drawings.

First of all, the first embodiment of the present invention will be explained in detail.

FIG. 2 is a block diagram showing a configuration of an apparatus for encoding image data according to the first embodiment of the present invention. Incidentally, here, it is assumed that a MH encoding system is employed as a one-dimensional encoding and a MR encoding system is employed as a two-dimensional encoding.

In the MR encoding system, an encoding efficiency is improved by utilizing correlation between adjacent lines on the basis of a MR encoding. That is, in the MR encoding system, each first line in every k lines (hereinafter, referred to as K parameter) is applied with the MR encoding system, and a two-dimensional encoding is then performed on the second line to k-th line with reference to data about the preceding line.

As shown in FIG. 2, image data transmitted from an external scanner section or the like is input in a one-dimensional encoder 2 via a run-length determination section 1. The image data is also input into a two-dimensional encoder 4 directly or a line memory section 3. In the run-length determination section 1, run-lengths about the image data are determined. This determination result is output to a Huffman table 5.

In the Huffman table 5, data corresponding to the above determination result is output to the one-dimensional encoder 2. An encoded data creating section 6 creates encoded data on the basis of the outputs of the one-dimensional encoder 2 and the two-dimensional encoder 4 to output the same to an external modem or the like. An in-K line encoding control section 7 controls the one-dimensional encoder 2, the two-dimensional encoder 4, the encoded data creating section 6, a thin line determination section 8 and a code switching control section 9 on the basis of setting of K parameter performed by an external main CPU or the like.

Here, the apparatus for encoding image data according to the first embodiment is characterized in that the thin line determination section 8 determines the frequency of occurrence of the thin line in the line on the basis of the determination result in the run-length determination section 1, namely the contents of the run-length value during the one-dimensional encoding, and the code switching control section 9 instructs the encoded data creating section 6 to restrict the number of lines of the subsequent lines to which the two-dimensional encoding is applied on the basis of the determination result in the thin line determination section 8.

That is, the frequency of occurrence of short run-length is determined from the run-length value during compression of lines applied with the one-dimensional encoding. When it is determined from the above determination result that many small characters and/or thin lines are contained in a document, namely the frequency of occurrence of short run-length is high, the number of lines applied with the two-dimensional encoding is restricted within a range specified by the K parameter.

Thereby, influence of an error on an image is reduced.

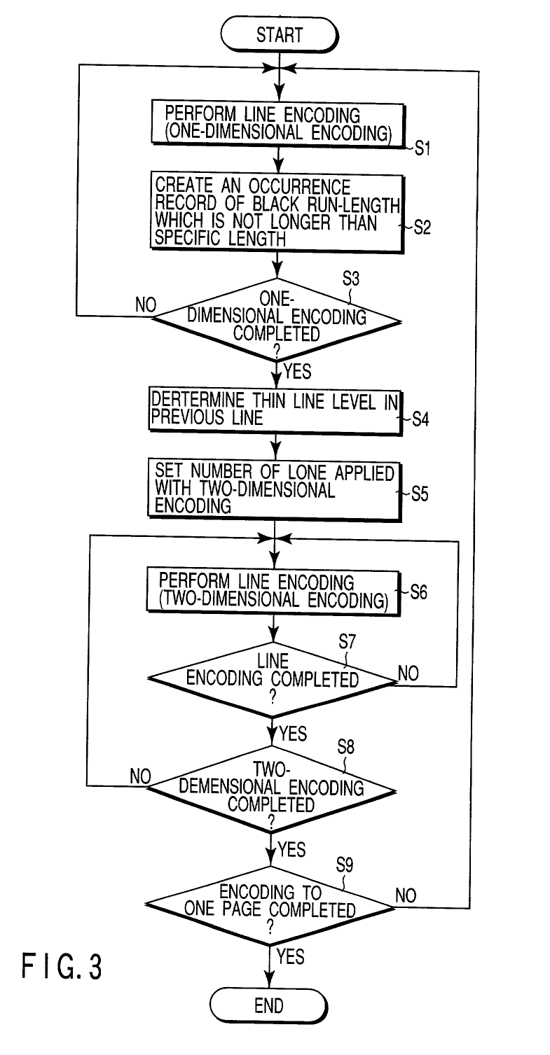

Characterized operation of the apparatus for encoding image data according to the first embodiment will be explained below in detail with reference to FIG. 3.

First of all, when the one-dimensional encoder 2 receives image data, it performs a line encoding (Step S1). At this time, the run-length determination section 1 creates an occurrence record of a black run-length which is not more than a specified length (Step S2). When the one-dimensional encoding on the first line is completed (Step S3), the thin line determination section 8 determines the frequency of occurrence of the thin line in the preceding line (Step S4). The number of lines applied with the two-dimensional encoding is set on the basis of this determination result (Step S5).

Next, a two-dimensional encoding is performed on the next line in the two-dimensional encoder 4 (Step S6). Then, when the line encoding is terminated (Step S7), the above two-dimensional encoding is repeated by the number of lines applied with the two-dimensional encoding, which has been set in the above Step S5 (Step S8). Thus, when the two-dimensional encoding is completed regarding the lines applied with the two-dimensional encoding, the above operation is repeated for all lines included to one page of a document.

When the encoding is completed on all lines corresponding to one page (Step S9), all the operations are terminated.

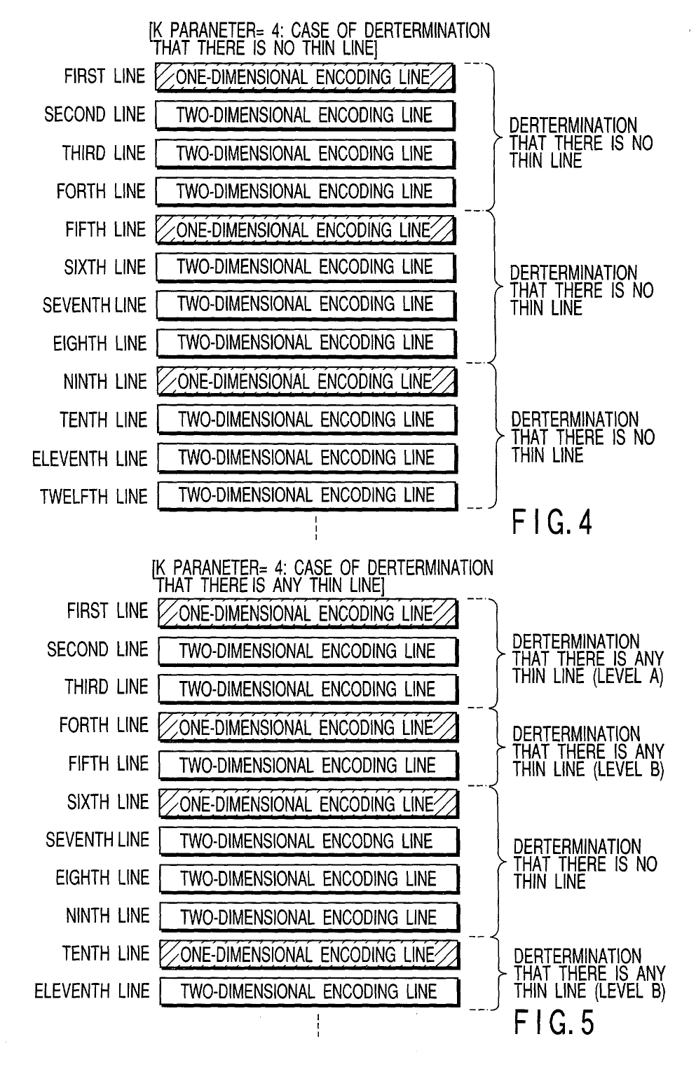

Here, a particular method where encoding is performed according to the characterizing operation will be explained with reference to FIGS. 4 and 5.

FIG. 4 shows an encoding process where K parameter set by an external main CPU (not shown) is “4”, and it has been determined from the determination result in the thin line determination section 8 that the frequency of occurrence of thin line is low.

In this case, the one-dimensional encoding is performed on the first line in the one-dimensional encoder 2, but it is determined in the thin line determination section 8 that the frequency of occurrence of thin line in the first line is low. Therefore, the two-dimensional encoding is performed on the second to fourth lines according to K parameter (=4) in the two-dimensional encoder 4. A similar processing is performed on the subsequent lines.

Meanwhile, FIG. 5 shows an encoding process where K parameter set by an external main CPU (not shown) is “4”, and it has been determined from the determination result in the thin line determination section 8 that the frequency of occurrence of thin line is high.

In this case, a one-dimensional encoding is performed on the first line in the one-dimensional encoder 2, but it is determined in the thin line determination section 8 that the frequency of occurrence of the thin line is high in the first line (level A). Therefore, the two-dimensional encoding should be performed on the second to fourth lines in the two-dimensional encoder 4 according to K parameter (=4), but the number of the lines to be applied with the two-dimensional encoding is set to the second and third lines so that the two-dimensional encoding is performed on the second and third lines.

Then, the one-dimensional encoding is performed on the fourth line in the one-dimensional encoder 2, again, but it is determined in the thin line determination section 8 that the frequency of occurrence of the thin line is high in the first line (level B). Therefore, the two-dimensional encoding should be performed on the fifth to seventh lines in the two-dimensional encoder 4 according to K parameter (=4), but the number of the line to be applied with the two-dimensional encoding is set to the fifth line so that the two-dimensional encoding is performed on the fifth line.

In this embodiment, there is the relationship of level B >level A. Therefore, in a case of level A, the number of lines to be applied with the two-dimensional encoding is set to “2”, while in a case of level B, the number of lines to be applied with the two-dimensional encoding is set to “1”. Incidentally, the present invention is not limited to this relationship.

Next, a second embodiment of the present invention will be explained.

An apparatus for encoding image data according to the second embodiment is characterized that the number of lines to be two-dimensionally encoded, which is included on an entire page is calculated on the basis of the determination result of the first line of the page.

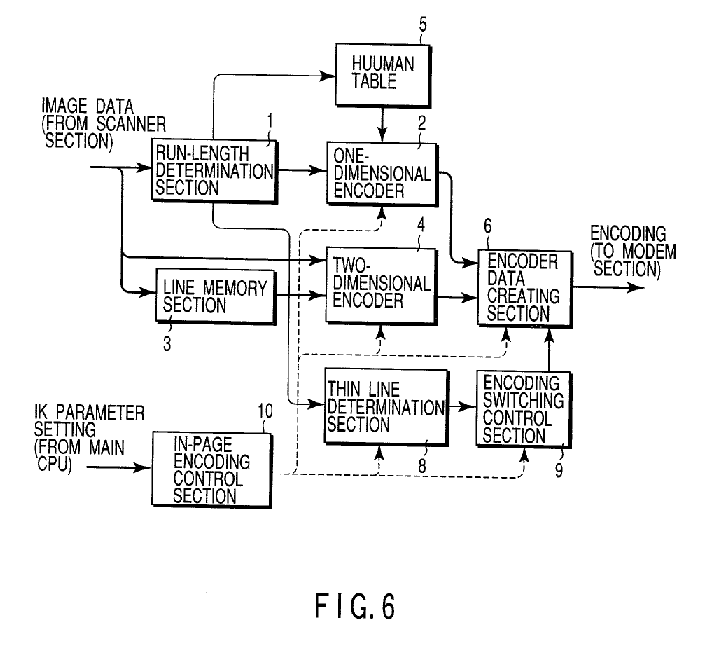

FIG. 6 is a block diagram showing a configuration of an apparatus for encoding image data according to the second embodiment of the present invention. Incidentally, here, it is assumed that a MH encoding system is employed as the one-dimensional encoding and a MR encoding system is employed as the two-dimensional encoding.

As shown in FIG. 6, the apparatus for encoding image data according to the second embodiment is different from that of the first embodiment only in a structure where an in-page encoding control section 10 is employed instead of the in-K line encoding control section 7 shown in FIG. 2. However, the apparatus of the second embodiment is the same as that of the first embodiment except for this structure.

That is, in the apparatus for encoding image data according to the second embodiment, the thin line determination section 8 determines the frequency of occurrence of a thin line in the line to be determined on the basis of the determination result of the run-length determination section 1, namely the contents of the run-length value during the one-dimensional encoding.

The apparatus of the second embodiment is characterized in that the encoding switching control section 9 instructs the encoded data creating section 6 to restrict the number of lines to be applied with the two-dimensional encoding within one page.

That is, the frequency of occurrence of a short run-length is determined from the run-length count value during compression of lines applied with the one-dimensional encoding. Then, when it is determined from the above determination result that many small characters and/or thin lines are included in a document, namely the frequency of occurrence of a short run-length is high, the number of lines applied with the two-dimensional encoding in one page is restricted.

Thereby, influence of an error on an image is reduced.

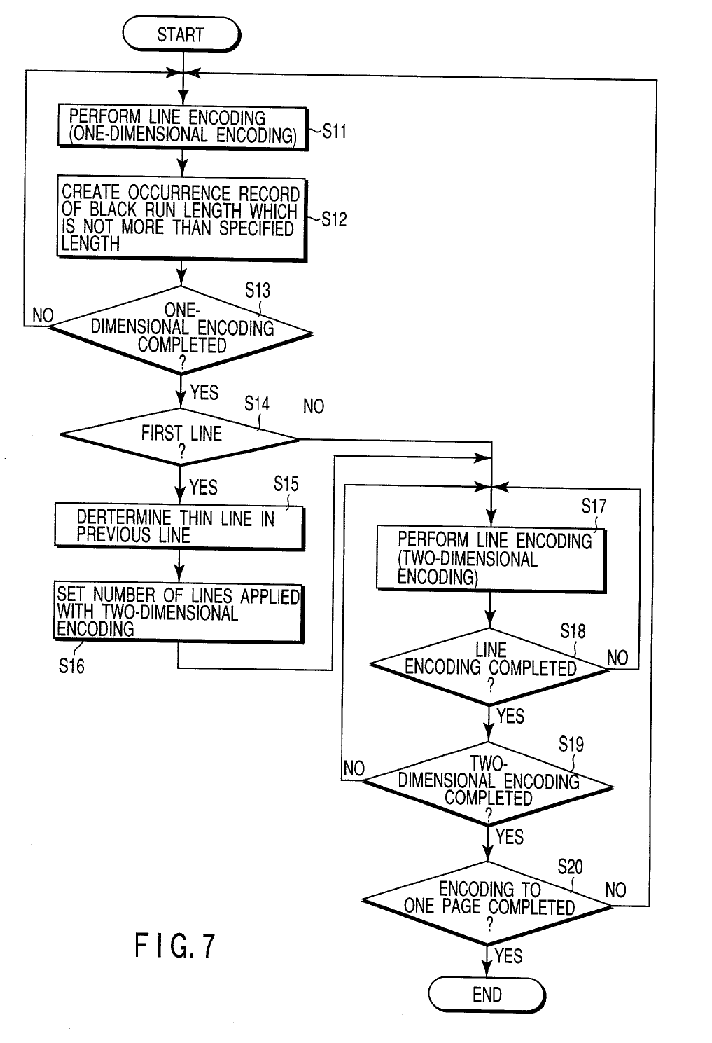

A characterized operation of the apparatus for encoding image data according to the second embodiment will be explained in detail with reference to FIG. 7.

First of all, when the one-dimensional encoder 2 receives image data, it performs line encoding (Step S11). At this time, the run-length determination section 1 creates an occurrence record of length of a black run equal to or less than a specified length (Step S12).

When the one-dimensional encoding is completed regarding the first line (Step S13), a determination is made about whether or not the line which has been determined is the first line (Step S14).

Here, when the line which has been determined is the first line, the thin line determination section 8 determines the frequency of occurrence of a thin line in the first line (Step S15). The number of lines to be applied with the two-dimensional encoding is set on the basis of the determination result (Step S16).

When it is determined in the Step S16 that the line which has been determined is not the first line, or after the Step S16, the control routine proceeds to Step S17 and the subsequent steps.

That is, the two-dimensional encoding is performed on the next line in the two-dimensional encoder 4 (Step S17). Then, when the line encoding is completed (Step S18), the two-dimensional encoding is repeated by the number of lines applied with the two-dimensional encoding, which has been set in the above Step S5 (Step S19).

In this manner, when the two-dimensional encoding is completed on the lines applied with the two-dimensional encoding, the above operation is repeated for the lines corresponding to one page. Then, when the encoding is completed about all the lines in one page (Step S20), all the operations are terminated.

Finally, a third embodiment of the present invention will be explained.

An apparatus for encoding image data according to the third embodiment is characterized in that the number of lines to be applied with the two-dimensional encoding is determined so as to correspond to a correction ability or capacity of a modem to be connected.

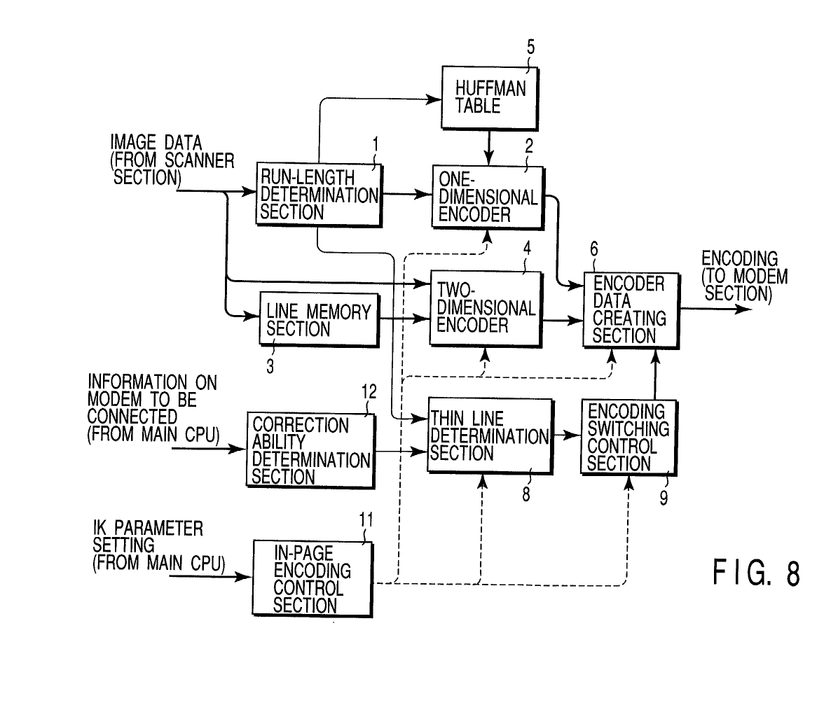

FIG. 8 is a block diagram showing a configuration of an apparatus for encoding image data according to the third embodiment of the present invention. Incidentally, it is assumed that a MH encoding system is employed as the one-dimensional encoding and a MR encoding system is employed as the two-dimensional encoding.

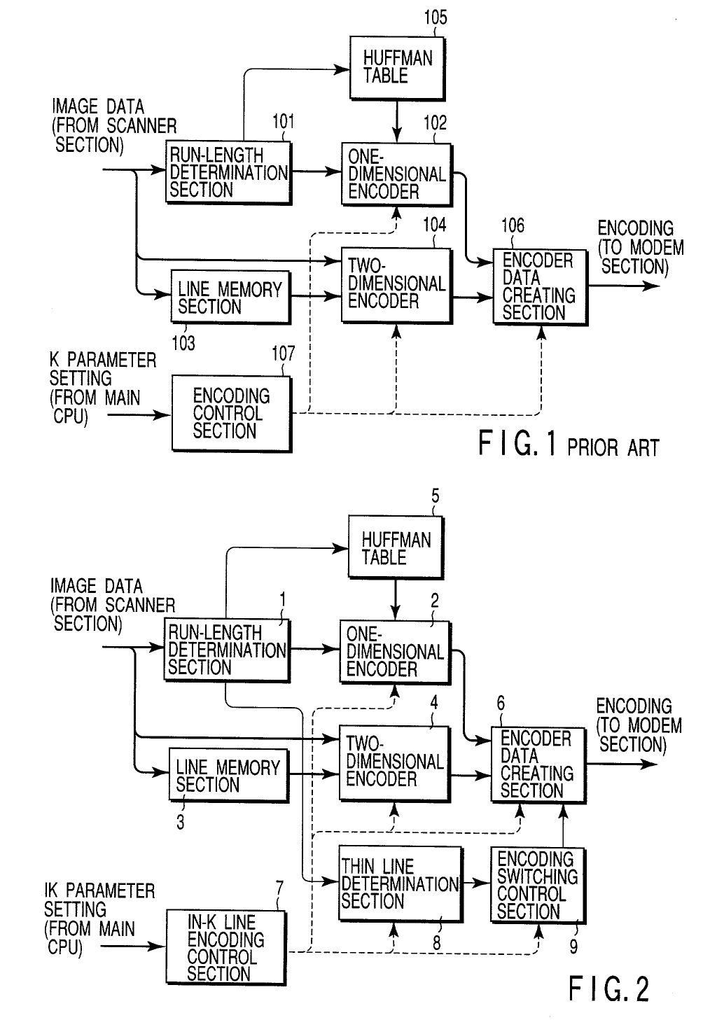

As shown in FIG. 8, the apparatus for encoding image data according to the third embodiment has a correction ability determination section 12 in addition to the configuration shown in FIG. 1.

That is, in the apparatus for encoding image data according to the third embodiment, the correction ability determination section 12 receives information on a modem to be connected from an external main CPU and it sends information on correction ability determination to the thin line determination section 8. The thin line determination section 8 determines the frequency of occurrence of a thin line in the line to be determined and the frequency of occurrence of communication error on the basis of the determination result in the run-length determination section 1, namely the contents of the run-length value during the one-dimensional encoding and the information on the correction ability determination from the correction ability determination section 12. The encoding switching control section 9 instructs the encoded data creating section 6 on the basis of the determination result to restrict the number of lines applied with the two-dimensional encoding, which are included in the next line and the subsequent lines within one page.

That is, the frequency of occurrence of a short run-length is determined from the run-length count value during compression of the lines applied with the one-dimensional encoding.

Then, when it is determined from the above determination result that many small characters and/or thin lines are included in a document, namely the frequency of occurrence of a short run-length is high, and the error correction ability of communication is low, the number of lines applied with the two-dimensional encoding within one page is restricted.

Thereby, influence of an error on an image is reduced.

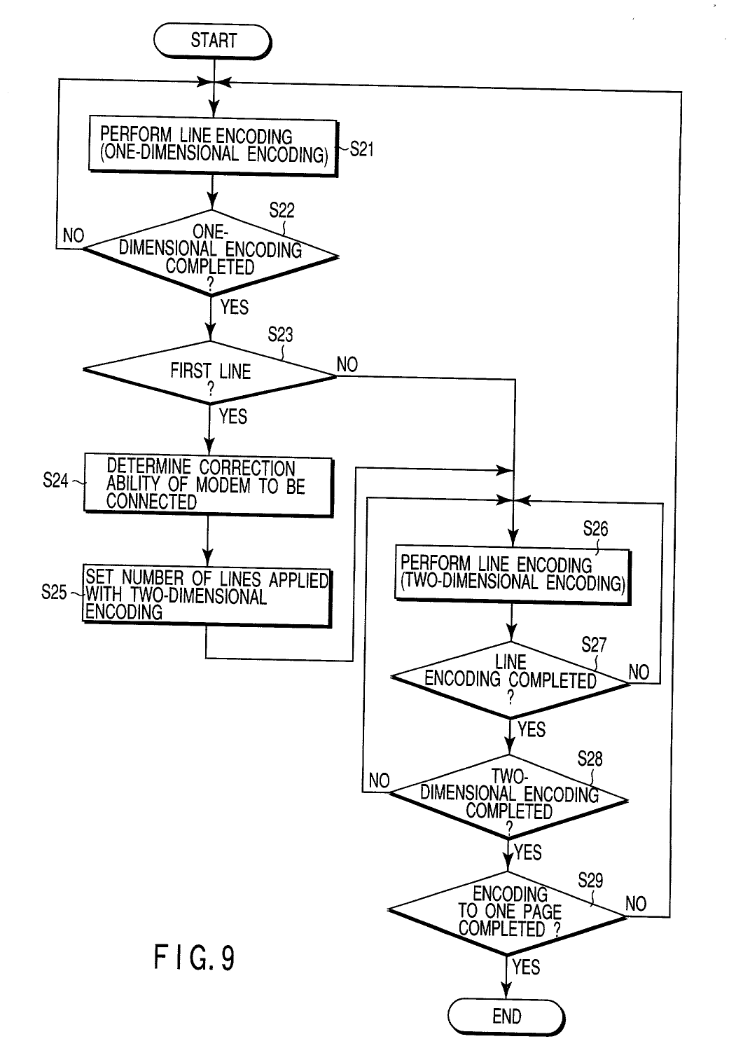

The characterized operation of the apparatus for encoding image data according to the third embodiment will be explained below in detail with reference to FIG. 9.

First of all, when the one-dimensional encoder 2 receives image data, it performs line encoding (Step S21).

After the one-dimensional encoding is completed on one line (Step S22), when the one line is the first line, the correction ability determination section 12 determines the correction ability of a modem to be connected on the basis of information on the modem (Step S24), so that the number of lines to be applied with the two-dimensional encoding is set on the basis of this determination result (Step S25).

After the processing in the above Step S25 is completed, or when it is determined that the one line is not the first line in the above Step S23, the two-dimensional encoding is performed on the next line in the two-dimensional encoder 4 (Step S26).

When the line encoding is completed (Step S27), the above two-dimensional encoding is repeated by the number of lines applied with the two-dimensional encoding, which has been set in the above Step S25 (Step S28). Thus, when the two-dimensional encoding is completed on the lines to be applied with the two-dimensional encoding, the above operations are repeated until encoding is completed for one page.

When the above encoding is completed for all the lines in one page (Step S29), all the operations are terminated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for encoding image data, comprising:
a one-dimensional encoder which encodes image data one-dimensionally;
a two-dimensional encoder which encodes image data two-dimensionally;
a thin line determination section which determines the frequency of occurrence of short run-length from a run-length count value during encoding of lines applied with the one-dimensional encoding; and
an encoding control section which, when it is determined from the determination result in the thin line determination section that the frequency of occurrence of the short run-length is high, restricts the number of lines which are applied with the second-dimensional encoding within a predetermined range.

2. An apparatus for encoding image data according to claim 1, wherein the encoding control section restricts the number of lines to be applied with the two-dimensional encoding, which are included in a whole page, on the basis of the determination result of the first line on the page in the thin line determination section.

3. An apparatus for encoding image data according to claim 1, further comprising a correction ability determination section which determines a correction ability of a modem to be connected,
wherein the encoding control section determines the number of lines to be applied with the two-dimensional encoding on the basis of the determination result of the correction ability determination section.

4. An apparatus for encoding image data; comprising:
a one-dimensional encoder which encodes image data one-dimensionally;
a two-dimensional encoder which encodes image data two-dimensionally;
a run-length determination section which determines run-lengths during encoding of lines applied with the one-dimensional encoding to obtain a runlength count value;
a thin line determination section which determines the frequency of occurrence of a short run-length on the basis of the run-length count value;
an encoding control section which is subjected to setting of K parameter externally and
when it is determined from the determination result in the thin line determination section that the frequency of occurrence of the short run-length is high, determines that many small characters and/or thin lines are contained in a document to restrict the number of lines applied with the two-dimensional encoding within a predetermined range specified by the K parameter.

5. An apparatus for encoding image data according to claim 4, wherein the encoding control section restricts the number of lines to be applied with the two-dimensional encoding, which are included in a whole page, on the basis of the determination result of the first line on the page in the thin line determination section.

6. An apparatus for encoding image data according to claim 4, further comprising a correction ability determination section which determines a correction ability of a modem to be connected, wherein the encoding control section determines the number of lines to be applied with the two-dimensional encoding on the basis of the determination result of the correction ability determination section.

7. A method for encoding image data comprising:
a first step of one-dimensionally encoding image data;
a second step of two-dimensionally encoding image data;
a third step of determining the frequency of occurrence of a short run-length from a run-length count value during encoding of lines applied with the one-dimensional encoding; and
a fourth step of restricting the number of lines applied with the two-dimensional encoding within a predetermined range when it is determined from the determination result that the frequency of occurrence of the short run-length is high.

8. A method for encoding image data according to claim 7, wherein the fourth step restricts the number of lines applied with the two-dimensional encoding of an entire page on the basis of the determination result of the first line on the page in the third step.

9. A method for encoding image data according to claim 7, further comprising a fifth step of determining a correction ability of a modem to be connected, wherein the fourth step determines the number of lines applied with the two-dimensional encoding on the basis of the determination result in the third step.

10. A method for encoding image data comprising:
a first step of one-dimensionally encoding image data;
a second step of two-dimensionally encoding image data;
a third step of determining short run-lengths during encoding of lines applied with the one-dimensional encoding to obtain a run-length count value;
a fourth step of determining the frequency of occurrence of the short run-length on the basis of the run-length count value;
a fifth step of performing setting of K parameter externally; and
a sixth step of determining that many small characters and/or thin lines are contained in a document to restrict the number of lines applied with the two-dimensional encoding within a predetermined range specified by the K parameter, when it is determining that the frequency of occurrence of the short run-length is high from the determination result in the fourth step.

11. A method for encoding image data according to claim 10, wherein the sixth step restricts the number of lines applied with the two-dimensional encoding on an entire page on the basis of the determination result of the first line on the page in the fourth step.

12. A method for encoding image data according to claim 10, further comprising a seventh step of determining a correction ability of a modem to be connected,
wherein the sixth step determines the number of lines applied with the two-dimensional encoding on the basis of the determination result in the fourth step.
